(19) United States
(12) Patent Application Publication
(10) Pub. No.: US 2006/0046793 A1
(43) Pub. Date: Mar. 2, 2006

(54) Universal accessory interface for mobile computing terminals

(76) Inventors: Alistair Hamilton, Stony Brook, NY (US); Sudhir Bhatia, Brooklyn, NY (US); Jorg Schlieffers, Streatley-on-Thames (GB)

Correspondence Address: Fay Kaplun & Marcin, LLP, Suite 702, 150 Broadway, New York, NY, 10038, US

(21) Appl. No.: 10/930,503

(22) Filed: Aug. 31, 2004

(51) Int. Cl. H04M 1/00

(52) U.S. Cl. 455/575.1

(57) ABSTRACT

Described is an accessory for a mobile computing device which has a first interface. The accessory include a second interface and a third interface. The second interface compliments the first interface for mating therewith to enable communication between the device and the accessory. The third interface is substantially similar to the first interface for mating with accessories adapted to mate with the first interface. The third interface is mounted on a first outward facing surface of the accessory so that, when the first and second interfaces are mated, the third interface faces outward.

### BACKGROUND INFORMATION

As advancements in mobile computing technology continue to allow for greater processing power in increasingly smaller devices, mobile computing terminals (“MCTs”, e.g., Personal Digital Assistants (“PDAs”), electronic organizers, mobile phones, etc.) have evolved into multi-purpose devices with the capability to perform the combined tasks of several other more traditional devices. Many of today's PDAs, for example, may also function as bar code scanners, magnetic stripe readers, music players, internet browsers, universal remote controls, cameras, gaming systems, etc. These multi-purpose MCTs are now commonly used by businesses and individuals alike for work and pleasure.

In order to accommodate these additional functionalities, essential hardware components must often be added to the MCTs. For instance, a PDA with the ability to capture images must at a minimum contain a lense. For better image quality, a flash bulb may also need to be added. However, with each additional component, sacrifices are made to the terminal's portability due to added size and weight. In the interest of limiting the terminal's size and because usually not all functions are used at the same time, the additional functionalities are frequently facilitated by external accessories attachable to expansion interfaces (e.g., USB, firewire, parallel ports, serial ports, etc.) on the MCT. Today, many MCTs may be complemented with external scanners, cameras, wireless adapters, keyboards, cablecups, speakers, etc.

Typically, these external accessories may be manufactured by various third parties and are created independent of each other. As a result, compatibility issues arise in which the insertion of one external accessory into an expansion interface prevents the insertion of another. With limited space for additional expansion interfaces, many MCTs are only able to function with one or two accessories at a time. Whenever a different accessory's functionality is desired, any interfering accessories must first be removed and therefore may not operate concurrently.

### SUMMARY OF THE INVENTION

The present invention relates to an accessory for a mobile computing device which has a first interface. The accessory include a second interface and a third interface. The second interface compliments the first interface for mating therewith to enable communication between the device and the accessory. The third interface is substantially similar to the first interface for mating with accessories adapted to mate with the first interface. The third interface is mounted on a first outward facing surface of the accessory so that, when the first and second interfaces are mated, the third interface faces outward.

### BRIEF DESCRIPTION OF THE DRAWINGS

FIG. 1 shows an exemplary embodiment of an MCT according to the present invention.

FIG. 2a shows a front perspective view of an exemplary embodiment of an external accessory according to the present invention.

FIG. 2b shows a rear perspective view of an exemplary embodiment of an external accessory according to the present invention.

FIG. 3 shows an exemplary embodiment of the MCT with an attached external accessory according to the present invention.

FIG. 4a shows an exemplary embodiment of a charging cradle for the MCT according to the present invention.

FIG. 4b shows an exemplary embodiment of the MCT connected to the charging cradle according to the present invention.

FIG. 4c shows an exemplary embodiment of the MCT with the attached external accessory connected to the charging cradle according to the present invention.

### DETAILED DESCRIPTION

The present invention may be further understood with reference to the following description and the appended drawings, wherein like elements are provided with the same reference numerals. The present invention relates to a universal physical interface that allows for the quick and simple permanent or non-permanent attachment of multiple external accessories to a single MCT. The electrical contacts of the MCT's expansion interface are extended through each successive accessory so that the combined accessories may operate concurrently, eliminating the need to remove any previous attachments.

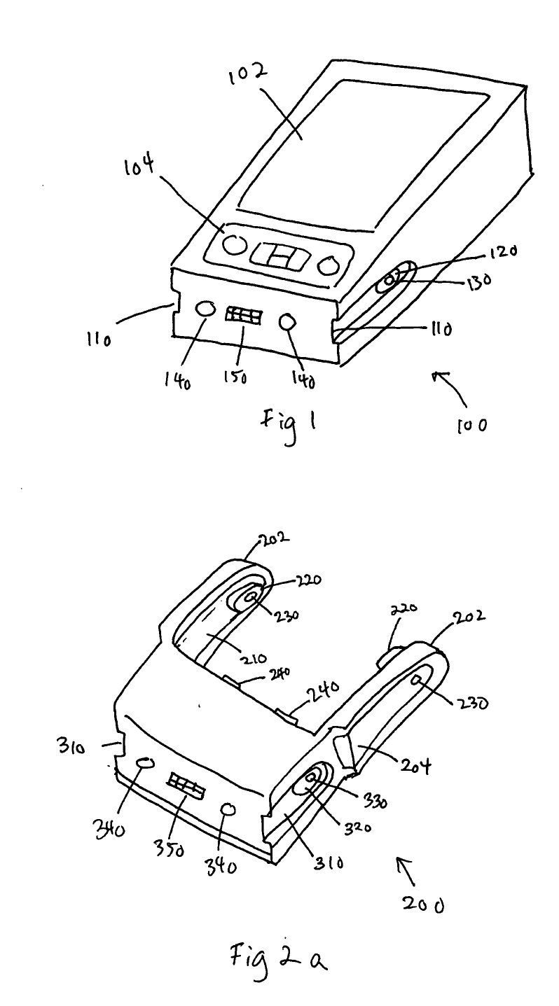

FIG. 1 shows an exemplary embodiment of an MCT 100 according to the present invention. No external accessories are attached, exposing the universal physical interface components. The MCT 100 may be any type of computer or processor based mobile device (e.g., a bar code reader, a PDA, a two-way pager, a mobile phone, a mobile optical reader, a digital camera, a music player, etc.). The MCT 100 may be portable and sufficiently small to be easily carried. The MCT 100 may be designed for a plurality of different uses/functionalities (e.g., reading bar codes, capturing images, playing music, etc.) and may have a plurality of integrated software and/or hardware components. Various additional uses/functionalities may be added to the MCT 100 through separate software and/or hardware modules. The MCT 100 may take on one or more additional functionalities through at least one expansion interface. In one embodiment, the MCT 100 is based on a personal digital assistant (“PDA”) such as those running the Microsoft Pocket PC 2003 operating system, or similar.

In the exemplary embodiment of FIG. 1, the MCT 100 includes a display 102, hard keys 104, an expansion interface 150, and recess slots 110, 120, 130, and 140. The display 102 may be any screen that provides visual output to the user. Manual input by the user may be accomplished through the hard keys 104, or if the display 102 is touch sensitive, through soft keys appearing on the display 102, or a combination thereof. The expansion interface 150 may be an interface capable of connecting an external accessory 200 to at least a portion of an electrical architecture of the MCT 100 (e.g., a USB interface, a firewire interface, a parallel interface, a serial interface, etc.).

The recess slots 110-140 facilitate the attachment of the external accessory 200 to the MCT 100 according to the present invention. Each of the recess slots 110-140 is a “female” receiving component that accepts a “male” counterpart of the external accessory 200. In particular, the recess slots 110-140 form cavities on side surfaces of the MCT 100 that may be coupled with corresponding protrusions molded onto surfaces of the external accessory 200. In order to avoid obstructing the display 102, the hard keys 104, or any other functional element on the MCT 100 surface, the expansion interface 150 and the recess slots 110-140 may be located together near either the top or bottom of the MCT 100. Thus, with the external accessory 120 attached, only the areas immediately housing those components are blocked and unavailable to the user.

Running up from both side surfaces of the MCT 100 are a first pair of identical recess slots 110. Within the recess slots 110 are a second pair of smaller recess slots 120 that retreat deeper into the MCT 100 body, which allow the external accessory 200 with complementary tabs or wings to snap rigidly onto the MCT 100. For a more permanent attachment, each of the recess slots 120 may house a brass insert recess slot 130 lined with spiral threads that may accept the treaded rod of a screw. Furthermore, to prevent the attached external accessory 200 from rotating around the MCT 100, a third pair of recess slots 140 may be added to a plane on the bottom surface of the MCT 100.

The foregoing embodiment of the MCT 100 should not be construed so as to limit the present invention in any way. As will be apparent to those skilled in the art, different types of MCTs may be used so long the recess slots 110-140 of the present invention are included and the MCTs may be expanded with additional accessories. The MCTs may be of any portable size and shape, and may also include additional functional components not present in this exemplary embodiment (e.g., speakers, microphones, wireless network antennas, toggle buttons, removable memory devices, etc.).

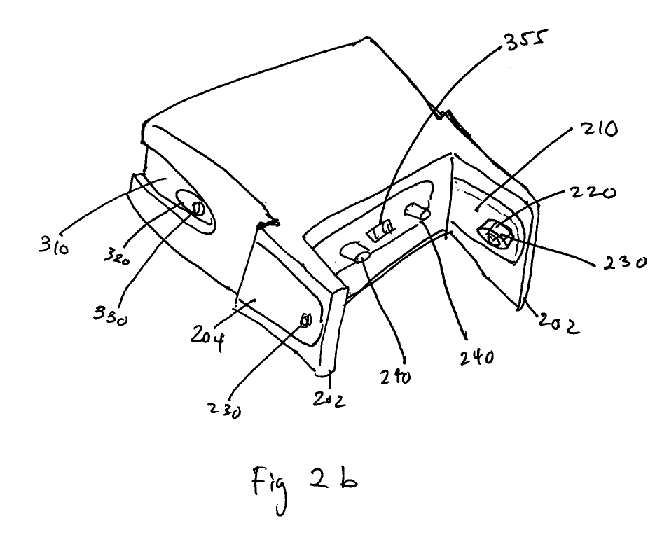

FIG. 2a shows an exemplary embodiment according to the present invention of the external accessory 200 attachable to the MCT 100. The main body of the accessory 200 houses components that provide one or more additional functionalities to the MCT 100. For example, the accessory 200 may be a wireless adapter that connects the MCT 100 to a wireless local area network (“WLAN”), a cablecup for recharging and/or wired data transfer, a magnetic stripe reader, a bar code scanner, a keyboard, a digital camera, a set of speakers, a memory device, a cradle for recharging a battery of the MCT 100, etc. Those of skill in the art will understand that the exemplary embodiments of the present invention may be used with any external accessory and that the accessory 200 is only exemplary.

Extending from the body of the accessory 200 are a pair of wings 202 from which the “male” counterparts 210, 220 and 240 to the “female” recess slots 110, 120, and 140 protrude. In particular, the protrusions 210, 220, and 240 complement the recess slots 110, 120, and 140, respectively. In this exemplary embodiment of the present invention, attachment of the accessory 200 to the MCT 100 only requires that the wings 202 be slid over the sides of the MCT 100 so that the recess slots 110, 120, and 140 are engaged by their counterparts of the accessory 200. Once snapped into an attached position, the accessory 200 is rigidly secured and ready for operation with the MCT 100, provided that any necessary software modules are loaded.

Removal of the attached accessory 200 from the MCT 100 may be accomplished by a pair of buttons 204 located on the outside of the wings 202. The buttons 204 are connected to the protrusions 210 and 220 such that, when depressed, the buttons 204 trigger a mechanism that lifts the protrusions 210 and 220 away from the recess slots 110 and 120, respectively. This may be accomplished, for example, if the bases of the wings 202 were hinged to the accessory 200 body, enabling the wings 202 to pivot away from the MCT 100 sides when both the buttons 204 are depressed. With the protrusions 210 and 220 disengaged from the recess slots 110 and 120, respectively, the accessory 200 and the MCT 100 may be separated simply by being pulled apart into a disattached position.

For a more permanent attachment, the accessory 200 may be screwed into the MCT 100 through apertures 230, which traverses the width of the wing 202 and through the protrusions 210 and 220. Like the brass insert recess slots 130, the apertures 230 are lined with spiral threats only large enough to allow the threaded rod, but not the head, of a screw to pass. When the accessory 200 is attached to the MCT 100 (i.e., in the attached position), the apertures 230 are aligned with the brass insert recess slots 130.

As indicated above, in addition to providing a quick and simple way to attach the external accessory 200 to the MCT 100, the present invention also enables the concurrent operation of multiple external accessories 200. An attached conventional external accessory may prevent further external accessories from operating with a mobile device. Consequently, only one accessory may be attached at a time. By extending the expansion interface and incorporating a set of recess slots into the accessory's body, however, the present invention allows an attachment of a potentially unlimited number of the accessories 200 to a single MCT 100.

Referring back to the exemplary embodiment of the accessory 200, for example, the recess slots 310-340 of the accessory 200 body are substantially identical to the recess slots 110-140, respectively, and thus, capable of engaging the physical interface components of another accessory. Moreover, the expansion interface 150 of the MCT 100 is duplicated by the expansion interface 350 of the accessory 200.

FIG. 2b shows a rear perspective view of an exemplary embodiment of the accessory 200. If the accessory 200 were the first accessory attached to the MCT 100, electrical contacts 355 may connect to at least a portion of the electrical architecture of the MCT 100 through the expansion interface 150. If instead the accessory 200 is to be attached to a further accessory (not shown) according to the present invention, the electrical contacts 355 may connect to at least a portion of an electrical architecture of that the further accessory through that other accessory's expansion interface. Therefore, the MCT 100 may be indirectly connected to and function with the further accessory which is not immediately attached to it. If the additional accessories lacked their own power source, power may also be provided by the MCT 100 via the inter-connected expansion interfaces.

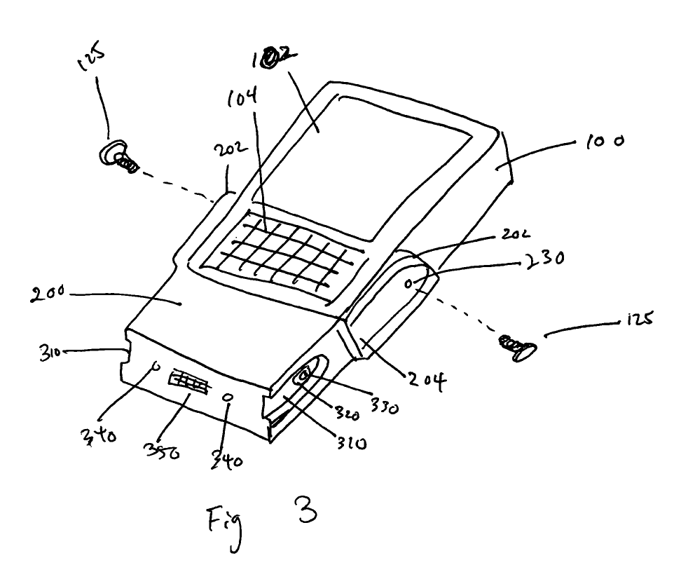

FIG. 3 shows an exemplary embodiment of an MCT 100 with the external accessory 200 is the attached position. The screws 125 may be used to permanently attached the accessory 200 to the MCT 100.

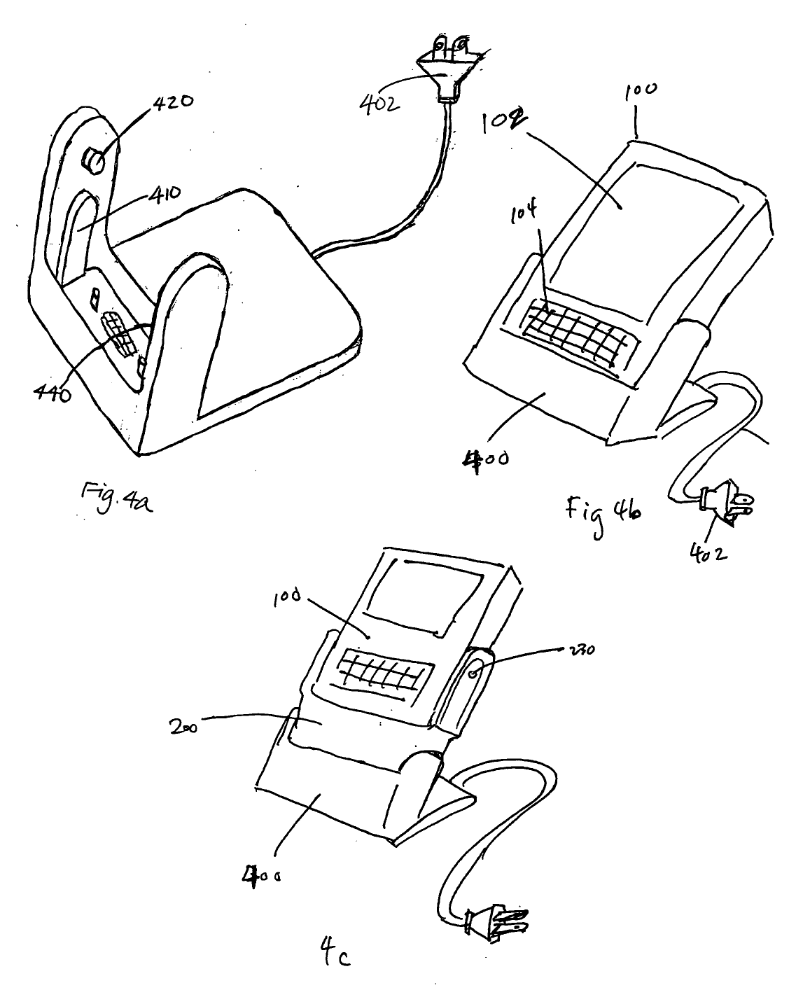

As an example of an additional accessory that may be attached to the attached accessory 200, FIG. 4a shows an exemplary embodiment of a charging cradle 400. In this exemplary embodiment, the charging cradle 400 includes an electrical plug 402 that may be plugged into an electrical outlet and at least one of the following physical interfaces: (1) a protrusion 410 and (2) a pair of guiderails 420, 440. At least one of the protrusions 410 and the guiderails 420, 440 may engage either the recess slots 110-140, 310-340 of the MCT 100 or the accessory 200. In a preferred embodiment, the guiderails 420, 440 are substantially aligned to slots 110 of the MCT 100 or slots 310 of the accessory 200. The preferred embodiment prevents the misalignment of the “female” recessed slots 110-140, 310-340 and their “male” counterparts and ensures that the connectors are joined properly, while not limiting or constraining the removal or placement of the MCT 100 into the cradle 400. FIG. 4b shows an exemplary embodiment of the MCT 100 attached to the charging cradle 400. FIG. 4c shows an exemplary embodiment of the MCT 100, the accessory 200 and the charging cradle 400 attached in succession. Thus, the MCT 100 may be charged without the need to remove the previously attached accessory 200.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. An accessory for a mobile computing device, the device having a first interface, comprising:
a second interface complementing the first interface for mating therewith to enable communication between the device and the accessory; and
a third interface substantially similar to the first interface for mating with accessories adapted to mate with the first interface, wherein the third interface is mounted on a first outward facing surface of the accessory so that, when the first and second interfaces are mated, the third interface faces outward.

2. The accessory according to claim 1, wherein the device includes at least one of a barcode reader, a two-way pager, a PDA, a mobile phone, a optical reader, a digital camera and a music player.

3. The accessory according to claim 1, wherein the accessory includes at least one of a wireless adapter, a cablecup, a magnetic stripe reader, a bar code scanner, a keyboard, a digital camera, a speaker, a memory device and a cradle.

4. The accessory according to claim 1, wherein the second interface is formed on a distal surface of the accessory.

5. The accessory according to claim 4, wherein a profile of a proximal portion of the accessory substantially matches that of a proximal portion of the device so that accessories configured for mounting on a proximal portion of the device may be mounted on the proximal portion of the accessory.

6. The accessory according to claim 5, wherein the device including a first surface on which the first interface is formed, a second surface including a display, a third surface opposite the second surface, a fourth surface and a fifth surface opposite to the fourth surface, and wherein the accessory further comprising:
a coupling arrangement for mounting the accessory on the device, wherein, when the accessory is in a mounted position, the coupling arrangement extends over and is mounted to a portion of at least one of the fourth surface and the fifth surface.

7. The accessory according to claim 6, wherein the coupling arrangement is mounted onto the device using at least one recess slot of the device, the least one recess slot located in at least one of the fourth and fifth surface.

8. The accessory according to claim 6, further comprising:
an attachment arrangement coupling the coupling arrangement to the device.

9. The accessory according to claim 8, wherein the attachment arrangement includes at least one screw, the coupling arrangement including at least one opening for receiving the at least one screw so that the coupling arrangement is permanently attached to the device.

10. An accessory for a mobile computing device, the device having a first interface formed on a first surface thereof, the device including a second surface including a display, a third surface opposite the second surface and a fourth surface, the accessory comprising:
a second interface formed on a distal surface of the accessory, the second interface complementing the first interface for mating therewith to enable communication between the device and the accessory;
a coupling arrangement for mounting the accessory on the device, wherein, when the accessory is in a mounted position, the coupling arrangement extends over and is mounted to a portion of the fourth surface; and
a third interface substantially similar to the first interface for mating with accessories adapted to mate with the first interface, wherein a profile of a proximal portion of the accessory substantially matches that of a proximal portion of the device so that accessories configured for mounting on a proximal portion of the device may be mounted on the proximal portion of the accessory.

11. An arrangement, comprising:
a mobile computing device including a first interface; and
an accessory including a second interface and a third interface, the second interface complementing the first interface for mating therewith to enable communication between the device and the accessory, the third interface substantially similar to the first interface for mating with accessories adapted to mate with the first interface, the third interface being mounted on a first outward facing surface of the accessory so that, when the first and second interfaces are mated, the third interface faces outward.

12. The arrangement according to claim 11, wherein the device includes at least one of a barcode reader, a two-way pager, a PDA, a mobile phone, a optical reader, a digital camera and a music player.

13. The arrangement according to claim 11, wherein the accessory includes at least one of a wireless adapter, a cablecup, a magnetic stripe reader, a bar code scanner, a keyboard, a digital camera, a speaker, a memory device and a cradle.

14. The arrangement according to claim 11, wherein the second interface is formed on a distal surface of the accessory.

15. The arrangement according to claim 13, wherein a profile of a proximal portion of the accessory substantially matches that of a proximal portion of the device so that accessories configured for mounting on a proximal portion of the device may be mounted on the proximal portion of the accessory.

16. The arrangement according to claim 15, wherein the device including a first surface on which the first interface is formed, a second surface including a display, a third surface opposite the second surface, a fourth surface and a fifth surface opposite to the fourth surface, and wherein the accessory further comprising:
a coupling arrangement for mounting the accessory on the device, wherein, when the accessory is in a mounted position, the coupling arrangement extends over and is mounted to a portion of at least one of the fourth surface and the fifth surface.

17. The arrangement according to claim 16, wherein the coupling arrangement is mounted onto the device using at least one recess slot of the device, the least one recess slot located in at least one of the fourth and fifth surface.

18. The arrangement according to claim 16, further comprising: an attachment arrangement coupling the coupling arrangement to the device.

19. The arrangement according to claim 18, wherein the attachment arrangement includes at least one screw, the coupling arrangement including at least one opening for receiving the at least one screw so that the coupling arrangement is permanently attached to the device.

20. The arrangement according to claim 11, further comprising:
a further accessory having a fourth interface and a fifth interface, the fourth interface complementing each of the first and third interfaces for mating therewith to enable communication between the device and the further accessory, the fifth interface substantially similar to each of the first and the third interfaces for mating with the accessories adapted to mate with each of the first and third interfaces, the fifth interface being mounted on a first outward facing surface of the further accessory so that, when one of (i) the first and fourth interfaces and (ii) the third and fourth interface are mated, the fifth interface faces outward.

21. The arrangement according to claim 12, wherein the further accessory communicates with the device by being one of (i) directly attached to the device and (ii) attached to the accessory which is attached to the device.
